(19) United States
(12) Patent Application Publication
(10) Pub. No.: US 2015/0371337 A1
(43) Pub. Date: Dec. 24, 2015

(54) Insurance Claim Outlier Detection with Variant of Minimum Volume Ellipsoids

(71) Applicant: Fair Isaac Corporation, San Jose, CA (US)

(72) Inventors: Jeremy M. Greene, San Marcos, CA (US); Vivek Bhardwaj, Bangalore (IN); Daniel Cociorva, San Diego, CA (US); Robin P, Bangalore (IN)

(21) Appl. No.: 14/313,215

(22) Filed: Jun. 24, 2014

(51) Int. Cl. G06Q 40/08

(52) U.S. Cl. CPC G06Q 40/08

(57) ABSTRACT

Data is received that includes a data set characterizing a plurality of insurance provider profiles and/or claims. Thereafter, a minimum volume ellipsoid is determined for the data set. Subsequently, at least one provider profile and/or claim is identified having at least one outlier variable based on a distance that the at least one provider profile and/or claim has relative to a center point of the minimum volume ellipsoid. Data is then provided (e.g., displayed, stored, loaded into memory, transmitted to a remote computing system, etc.) that characterizes the at least one provider profile and/or claim as likely being fraudulent or erroneous. In other variations, the minimum volume ellipsoid is determined using a different data set. Related apparatus, systems, techniques and articles are also described.

### TECHNICAL FIELD

The subject matter described herein relates to the detection of outliers in connection with insurance claims by using a variant of minimum volume ellipsoids.

### BACKGROUND

Unsupervised outlier detection techniques have been applied to a variety of problems including insurance claim processing to identify fraud, waste, and abuse in connection with claims and providers. The insurance claim information can include data at varying granularity levels and can be aggregated to different entities. For example, the insurance claim information can be aggregated to the provider level with various attributes characterizing each provider. In this example, provider profiles can be created with many variables such as charge amounts per procedure, charge amounts per patient, number of procedures for a particular patient, and the like. Often times, the entity's profile contains many variables. Therefore, identifying fraud, waste, and abuse of the given entity relies on the ability to use robust unsupervised techniques to detect outliers in a multidimensional space using such variables derived from the insurance claims information.

### SUMMARY

In one aspect, data is received that includes a data set characterizing a plurality of insurance provider profiles. Thereafter, a minimum volume ellipsoid is determined for the data set. Subsequently, at least one provider profile is identified having at least one outlier variable based on a distance that the at least one provider profile has relative to a center point of the minimum volume ellipsoid. Data is then provided (e.g., displayed, stored, loaded into memory, transmitted to a remote computing system, etc.) that characterizes the at least one provider profile as likely being fraudulent or erroneous.

A subset S of the provider profiles can be determined that minimizes the determinant of a covariance matrix C_{S}. Once S is found, the covariance matrix C_{S} is computed. In addition, a vector of column means of S, μₛ, is computed. The Mahalanobis distance, M(x), can be computed for each provider profile using:

M(x)=\sqrt{(x−μ_{S})^{T}C_{S}†(x−μ_{S})}.

In an interrelated variation, similar techniques can be applied to insurance claims. For example, data can be received that includes a data set characterizing a plurality of insurance claims. Next, a minimum volume ellipsoid is determined for the data set. At least one claim is then identified that has at least one outlier variable based on a distance that the at least one claim has relative to a center point of the minimum volume ellipsoid. Thereafter, data is provided that characterizes the at least one claim as likely being fraudulent or erroneous.

In a further interrelated aspect, data is received that includes a data set characterizing a plurality of insurance claims. Thereafter, using a previously generated minimum volume ellipsoid from a different data set, at least one claim is identified having at least one outlier variable based on a distance that the at least one claim has relative to a center point of the minimum volume ellipsoid. Data is then provided that characterizes the at least one claim as likely being fraudulent or erroneous.

In yet a further interrelated aspect, data is received that includes a data set characterizing a plurality of insurance provider profiles. Next, using a previously generated minimum volume ellipsoid from a different data set, at least one provider profile is identified having at least one outlier variable based on a distance that the at least one provider profile has relative to a center point of the minimum volume ellipsoid. Data is then provided that characterizes the at least one provider profile as likely being fraudulent or erroneous.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current outlier detection techniques result in fewer false positives and can be applied to any multidimensional unsupervised outlier detection problem.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a first diagram illustrating the use of Minimum Volume Ellipsoids in connection with insurance claims analysis;

FIG. 2 is a second diagram illustrating the use of Minimum Volume Ellipsoids in connection with insurance claims analysis; and

FIG. 3 is a diagram illustrating a process for insurance claim outlier detection using a variant of Minimum Volume Ellipsoids.

### DETAILED DESCRIPTION

The current subject matter is directed to a variant of Minimum Volume Ellipsoids (MVE) in order to identify the outliers in a multidimensional distribution. While the current description is mainly directed to the processing and characterization of healthcare insurance claims, it will be appreciated that the current subject matter is applicable to any multivariable unsupervised outlier detection problem. In particular, the current subject matter can be applied to auto insurance, property and casualty insurance, and the like.

The insurance claim information can include data at varying granularity levels and can be aggregated to different entities. For example, the insurance claim information can be aggregated to the provider level with various attributes characterizing each provider, or it can be at the claim level, or it can be at a sub-claim level. Other data characterizing insurance claims can also be considered herein. Outliers can be in a multidimensional space using variables derived from insurance claims information; for example, with regard to charge amounts per procedure, charge amounts per patient, number of procedures for a particular provider, number of procedures for a particular patient, and the like.

In one example, every month, insurance provider profiles are created based on a 12-month rolling year. Once these provider-year profiles are created, the profiles can be sent through an unsupervised outlier detection algorithm to score and rank the providers based on aberrancy. It will be appreciated that the current subject matter can be applied to data at varying granularity levels ranging from provider to claim to sub-claim and the like.

As outliers can skew principal components and other estimations, a subset, S, of provider-year profiles is identified that minimizes the determinant of the covariance matrix, C_{S}:

$$S = {argmin}_{{S}_{\begin{matrix}subset of provider - \\ year of profiles\end{matrix}}} det ( {C}_{S} ) .$$

Once S is identified, a robust covariance matrix, C_{S}, can be computed and a vector of column means of S, called μₛ, is generated. This vector of column means, μₛ, represents a robust estimate of the center of the data. Then, the generalized inverse of C_{S} can be used to compute the Mahalanobis distance, M(x), of each provider-year profile:

M(x)=\sqrt{(x−μ_{S})^{T}C_{S}†(x−μ_{S})}.

This Mahalanobis metric uses concentric multidimensional ellipsoids to measure distance. The axes of these concentric multidimensional ellipsoids point in the directions of the eigenvectors of C_{S} and the shape of the ellipsoids is directly related to the eigenvalues of C_{S}. These distances, M(x), can become the raw scores for each provider-year profile, where the higher the score, the more likely the provider is an outlier.

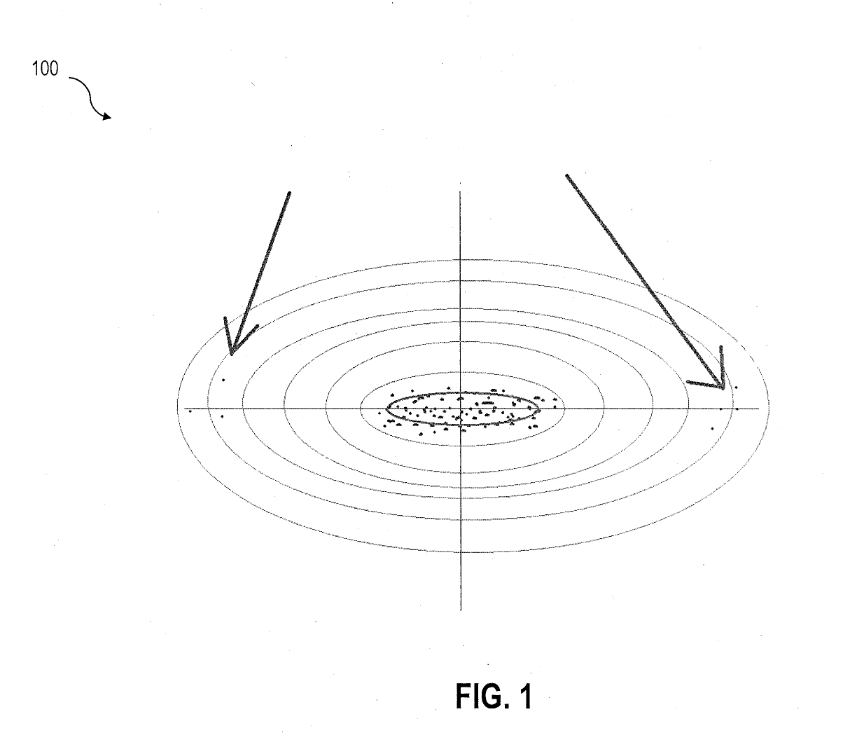

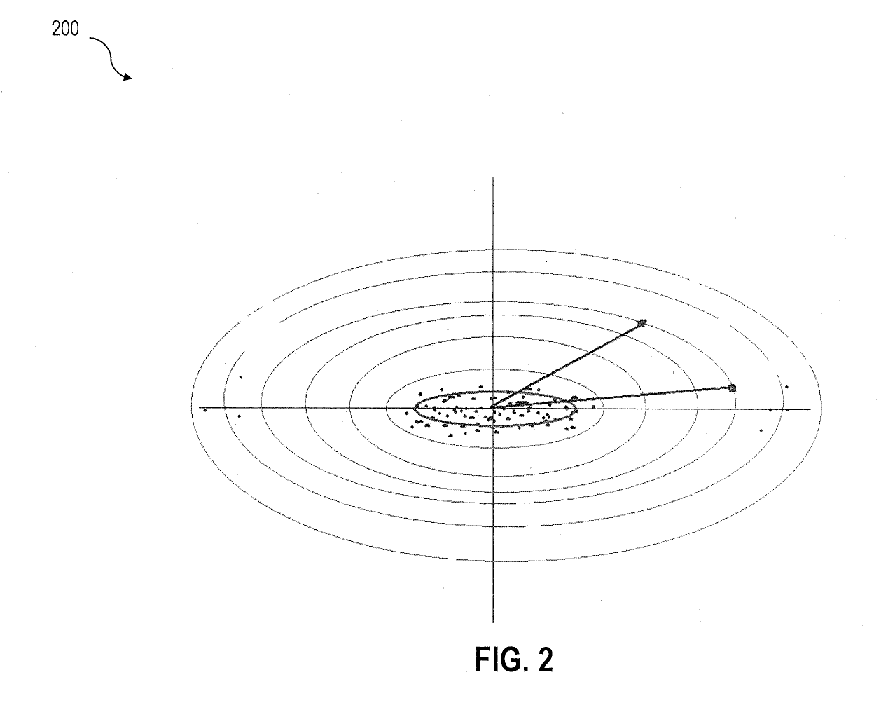

In diagram 100 of FIG. 1, the points represent entity profiles in two dimensions and the parameters C_{S} and μₛ have been found in order to use the Mahalanobis distance to flag outliers as shown by the arrows. Diagram 200 of FIG. 2 shows two provider-year profiles (the points) and their Mahalanobis distances to the center of the concentric ellipses (the length of the lines). Note that these two provider-year profiles actually sit on the same level-curve ellipse, so their respective Mahalanobis distances will be equal.

The current subject matter can be applied to domains other than healthcare insurance, such as, auto insurance and property and casualty insurance. In auto insurance fraud models or property and casualty insurance fraud models, analysts may be interested in the policy holder, policy, incident, exposure, or the current snapshot of a claim as an entity being an outlier. Profiles consisting of many meaningful variables can be created for the concerned entity from the data. Each profile represents a point in the multidimensional space. The MVE algorithm presented herein can be used on these multidimensional profiles to find the outliers.

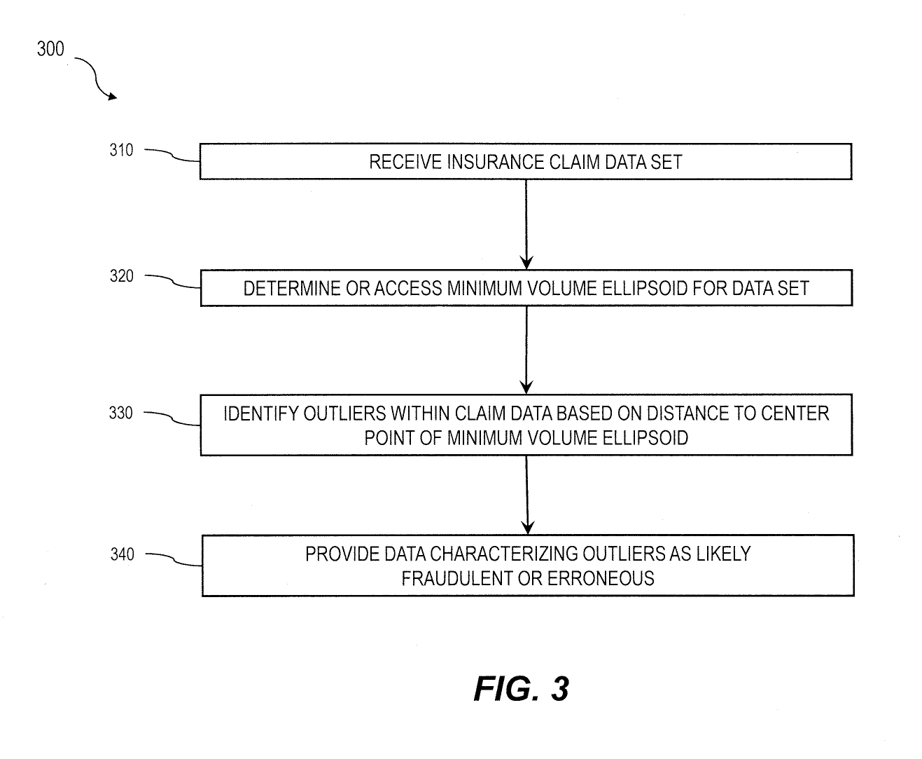

FIG. 3 is a diagram 300 in which, at 310, data is received comprising a data set characterizing a plurality of insurance claims (e.g., provider profiles, etc.). Thereafter, at 320, a minimum volume ellipsoid for the data set is determined or accessed (if already defined using a different data set). Subsequently, at 330, at least one claim is identified having at least one outlier variable based on a distance that the at least one claim has relative to a center point of the minimum volume ellipsoid. Next, at 340, data is provided (e.g., displayed, transmitted, stored, loaded into memory, etc.) that characterizes the at least one claim as likely being fraudulent or erroneous.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data comprising a data set characterizing a plurality of insurance provider profiles;
determining a minimum volume ellipsoid for the data set;
identifying at least one provider profile having at least one outlier variable based on a distance that the at least one provider profile has relative to a center point of the minimum volume ellipsoid; and
providing data characterizing the at least one provider profile as likely being fraudulent or erroneous.

2. The method of claim 1 further comprising:
determining a subset S of the provider profiles that minimizes the determinant of a covariance matrix Cs.

3. The method of claim 2 further comprising:
computing the covariance matrix Cs.

4. The method of claim 3 further comprising:
computing a vector of column means of S, uₛ.

5. The method of claim 4 further comprising:
computing the Mahalanobis distance M(x) for each provider profile using:
M(x)=\sqrt{(x−μ_{S})^{T}C_{S}†(x−μ_{S})}.

6. The method of claim 1, wherein at least one of the receiving, determining, identifying, and providing are implemented by at least one data processor forming part of at least one computing system.

7. A method comprising:
receiving data comprising a data set characterizing a plurality of insurance claims;
determining a minimum volume ellipsoid for the data set;
identifying at least one claim having at least one outlier variable based on a distance that the at least one claim has relative to a center point of the minimum volume ellipsoid; and
providing data characterizing the at least one claim as likely being fraudulent or erroneous.

8. The method of claim 7 further comprising:
determining a subset S of the claim profiles that minimizes the determinant of a covariance matrix Cs.

9. The method of claim 8 further comprising:
computing the covariance matrix Cs.

10. The method of claim 9 further comprising:
computing a vector of column means of S, μₛ.

11. The method of claim 10 further comprising:
computing the Mahalanobis distance M(x) for each claim using:
M(x)=\sqrt{(x−μ_{S})^{T}C_{S}†(x−μ_{S})}.

12. The method of claim 7, wherein at least one of the receiving, determining, identifying, and providing are implemented by at least one data processor forming part of at least one computing system.

13. A method comprising:
receiving data comprising a data set characterizing a plurality of insurance claims;
identifying, using a previously generated minimum volume ellipsoid from a different data set, at least one claim having at least one outlier variable based on a distance that the at least one claim has relative to a center point of the minimum volume ellipsoid; and
providing data characterizing the at least one claim as likely being fraudulent or erroneous.

14. The method of claim 13, wherein the previously generated minimum volume ellipsoid is generated by:
determining a subset S of the claim profiles that minimizes the determinant of a covariance matrix Cs;
computing the covariance matrix Cs; and
computing a vector of column means of S μₛ.

15. The method of claim 14, wherein the previously generated minimum volume ellipsoid is used to:
compute the Mahalanobis distance M(x) for each claim profile using:
M(x)=\sqrt{(x−μ_{S})^{T}C_{S}†(x−μ_{S})}.

16. The method of claim 13, wherein at least one of the receiving, determining, identifying, and providing are implemented by at least one data processor forming part of at least one computing system.

17. A method comprising:
receiving data comprising a data set characterizing a plurality of insurance provider profiles;
identifying, using a previously generated minimum volume ellipsoid from a different data set, at least one provider profile having at least one outlier variable based on a distance that the at least one provider profile has relative to a center point of the minimum volume ellipsoid; and
providing data characterizing the at least one provider profile as likely being fraudulent or erroneous.

18. The method of claim 17, wherein the previously generated minimum volume ellipsoid is generated by:
determining a subset S of the provider profiles that minimizes the determinant of a covariance matrix Cs;
computing the covariance matrix Cs;
computing a vector of column means of S μₛ; and

[symbol]

19. The method of claim 18, wherein the previously generated minimum volume ellipsoid is used to:
compute the Mahalanobis distance M(x) for each provider profile using:
M(x)=\sqrt{(x−μ_{S})^{T}C_{S}†(x−μ_{S})}.

20. The method of claim 17, wherein at least one of the receiving, determining, identifying, and providing are implemented by at least one data processor forming part of at least one computing system.
